(19) United States
(12) Patent Application Publication
(10) Pub. No.: US 2016/0271740 A1
(43) Pub. Date: Sep. 22, 2016

(54) WELDING JOINT HAVING REMARKABLE IMPACT RESISTANCE AND ABRASION RESISTANCE

(71) Applicant: POSCO, Pohang-si (KR)

(72) Inventors: Bong-Keun Lee, Pohang-si (KR); Il-Wook Han, Pohang-si (KR); Sang-Chul Lee, Pohang-si (KR); Jeong-Kil Kim, Pohang-si (KR); Dong-Ryeol Lee, Pohang-si (KR); Geug Kim, Pohang-si (KR)

(21) Appl. No.: 15/035,598

(22) PCT Filed: Oct. 2, 2014
(86) PCT No.: PCT/KR2014/009314

§ 371 Date: May 10, 2016

(30) Foreign Application Priority Data
Dec. 6, 2013 (KR) 10-2013-0151813

(51) Int. Cl. B23K 35/30; C22C 38/00; C22C 38/42; C22C 38/02; C22C 38/58; C22C 38/54

(52) U.S. Cl. CPC B23K 35/3073; C22C 38/58; C22C 38/54; C22C 38/42; C22C 38/02; C22C 38/002; C22C 38/001

(57) ABSTRACT

Provided is a welding joint having remarkable impact resistance and abrasion resistance. The welding joint having remarkable impact resistance and abrasion resistance comprises 0.02-0.75 wt % of C, 0.2-1.2 wt % of Si, 15-27 wt % of Mn, 2-7 wt % of Cr, 0.025 wt % or less of S, 0.025 wt % or less of P, 0.001-0.4 wt % of N, and the balance of Fe and other inevitable impurities, and having a stacking-fault energy of 15-40 mJ/m² at 20° C. Further provided are a welding joint having remarkable low temperature impact toughness and abrasion resistance, and a welding joint very preferably applied to a slurry pipe and the like used in the oil sand industry field related to oil production.

### TECHNICAL FIELD

The present disclosure relates to a welding joint having high impact resistance and abrasion resistance.

### BACKGROUND ART

Recent high oil price have increased interest in methods of producing oil at low cost. Accordingly, techniques for separating crude oil in massive amounts have been developed, and there is increasing interest in the oil sands industry. The term “oil sands” was originally used to refer to sand or sandstone containing crude oil and is now used to refer to all kinds of rock such as sedimentary rock that exist in oil reservoirs and contain crude oil. Oil production methods of extracting crude oil from oil sands are relatively new methods, as compared to existing oil production methods of extracting crude oil from oil wells, and are expected to undergo further development to reduce production costs.

However, oil sands generally contain large amounts of impurities together with crude oil. Therefore, an impurity removing process is performed when extracting crude oil from oil sands. After mining oil sands, the oil sands are transferred a certain distance to separation equipment so as to extract crude oil from the oil sands, and then separation pipes are used to separate impurities and crude oil from the oil sands. In the separation pipes, crude oil and impurities (such as rock, gravel, and sand) are rotated using water to allow crude oil floating on the water to be collected. Basically, such pipes are required to have a high degree of strength. In addition, such pipes are required to have impact resistance and abrasion resistance, because rock and gravel contained in the pipes impact the interior surfaces of pipes, and are required to have impact toughness to withstand low-temperature environments, for example, environments in which temperatures can fall to −29° C. Particularly, welding joints are strictly required to have such properties because welding joints are weaker than base metals. The physical properties of base metals may be adjusted through processes such as heat treatment processes, rolling processes, or controlled cooling processes so that the base metals may have the highest abrasion resistance and impact toughness obtainable from the compositions of the base metals. However, welding joints are mainly formed of welding materials and have internal structures similar to that formed by a casting process. Thus, it may be difficult to impart desired physical properties to welding joints.

Currently, pipes widely used for mining oil sands are API X65, X70, etc. However, welding joints formed on API X65 and X70 pipes have low impact toughness and abrasion resistance. Thus, the development of welding joints for replacing such welding joints is required.

### DISCLOSURE

### Technical Problem

An aspect of the present disclosure may provide a welding joint having a high degree of low-temperature impact toughness and a high degree of abrasion resistance.

### Technical Solution

One embodiment of the present invention provides a welding joint having remarkable impact resistance and abrasion resistance, comprising 0.02-0.75 wt % of C, 0.2-1.2 wt % of Si, 15-27 wt % of Mn, 2-7 wt % of Cr, 0.025 wt % or less of S, 0.025 wt % or less of P, 0.001-0.4 wt % of N, and the balance of Fe and other inevitable impurities, and having a stacking-fault energy of 15-40 mJ/m² at 20° C.

### Advantageous Effects

Embodiments of the present disclosure provide a welding joint having a high degree of low-temperature impact toughness and a high degree of abrasion resistance. Thus, the welding joint may be usefully used for manufacturing parts such as slurry pipes used in the oil sands industry to produce oil.

### BEST MODE

The inventors have conducted research into developing techniques for forming welding joints having high degrees of low-temperature impact toughness and abrasion resistance on high-manganese oil sands separation pipes designed to, for example, extract crude oil from oil sands. During the research, the inventors have found that if alloying elements and stacking fault energy are properly controlled, the above-described properties can be guaranteed, and based on this knowledge the inventors have invented the present invention.

Alloying elements will now be described according to an exemplary embodiment of the present disclosure.

C: 0.02 wt % to 0.75 wt %

Carbon (C) guarantees the strength and hardenability of welding joints and facilitates stable formation of austenite that imparts low-temperature impact toughness to welding joints. However, if the content of carbon (C) is less than 0.02 wt %, the strength of welding joints and stable formation of austenite are not guaranteed, and thus low-temperature impact toughness is not obtained. The strength of welding joints increases in proportion to the content of carbon (C). However, if the content of carbon (C) is greater than 0.75 wt %, stacking fault energy increases, and thus slippage occurs instead of twinning during plastic deformation. In this case, abrasion resistance decreases. Therefore, it may be preferable that the content of carbon (C) be within the range of 0.02 wt % to 0.75 wt %.

Si: 0.2 wt % to 1.2 wt %

Silicon (Si) functions as a deoxidizer and improves weldability by increasing the spreadability of molten metal during welding. In addition, silicon (Si) improves strength by solid-solution strengthening. To obtain the above-mentioned effects, it may be preferable that the content of silicon (Si) be within the range of 0.2 wt % or greater. However, if the content of silicon (Si) is greater than 1.2 wt %, the low-temperature impact toughness of welding joints may decrease, for example, due to the occurrence of segregation in the welding joints. Therefore, it may be preferable that the content of silicon (Si) be within the range of 0.2 wt % to 1.2 wt %.

Mn: 15 wt % to 27 wt %

Manganese (Mn) increases work hardening and guarantees stable formation of austenite even at a low temperature. Thus, the addition of manganese (Mn) may be needed. In addition, manganese (Mn) forms carbides together with carbon (C) and functions as an austenite stabilizing element like nickel (Ni). If the content of manganese (Mn) is less than 15 wt %, austenite may not be sufficiently formed, and thus low-temperature impact toughness may decrease. Conversely, if the content of manganese (Mn) is greater than 27 wt %, large amounts of fumes may be generated during welding, and abrasion resistance may decrease because slippage occurs instead of twining during plastic deformation. Therefore, it may be preferable that the content of silicon (Si) be within the range of 15 wt % to 27 wt %.

Cr: 2 wt % to 7 wt %

Chromium (Cr) is a ferrite stabilizing element, and the addition of chromium (Cr) enables decreasing the amounts of austenite stabilizing elements. In addition, chromium (Cr) facilitates the formation of carbides such as MC or M₂₃C₆. That is, if a certain amount of chromium (Cr) is added, precipitation hardening may be promoted, and the amounts of austenite stabilizing elements may be reduced. Thus, the addition of a certain amount of chromium (Cr) may be needed. In addition, since chromium (Cr) is a powerful anti-oxidation element, the addition of chromium (Cr) may increase resistance to oxidation in an oxygen atmosphere. If the content of chromium (Cr) is less than 2 wt %, the formation of carbides such as MC or M₂₃C₆ in welding joints may be suppressed, thereby decreasing abrasion resistance and increasing abrasion. Conversely, if the content of chromium (Cr) is greater than 7 wt %, manufacturing costs may increase, and abrasion resistance may steeply decrease. Therefore, it may be preferable that the content of chromium (Cr) be within the range of 2 wt % to 7 wt %.

S: 0.025 wt % or Less

Sulfur (S) is an impurity causing high-temperature cracking together with phosphorus (P), and thus it may be preferable that the content of sulfur (S) be adjusted to be as low as possible. Particularly, if the content of sulfur (S) is greater than 0.025 wt %, compounds having a low melting point such as FeS are formed, and thus high-temperature cracking may be induced. Therefore, preferably, the content of sulfur (S) may be adjusted to 0.025 wt % or less, so as to prevent high-temperature cracking.

P: 0.025 wt % or Less

Phosphorous (P) is an impurity causing high-temperature cracking, and thus it may be preferable that the content of phosphorus (P) be adjusted to be as low as possible. Preferably, the content of phosphorus (P) may be adjusted to be 0.025 wt % or less, so as to prevent high-temperature cracking.

N: 0.001 wt % to 0.4 wt %

Nitrogen (N) improves corrosion resistance and stabilizes austenite. That is, the addition of nitrogen (N) leads to an effect similar to the effect obtainable by the addition of carbon (C). Therefore, nitrogen (N) may be added as a substitute for carbon (C). In addition, nitrogen (N) may combine with other alloying elements and form nitrides which may particularly improve abrasion resistance. To obtain the above-described effects, it may be preferable that the content of nitrogen (N) be 0.001 wt % or greater. However, if the content of nitrogen (N) is greater than 0.4 wt %, impact toughness may markedly decrease. Therefore, it may be preferable that the content of nitrogen (N) be within the range of 0.001 wt % to 0.4 wt % or less.

According to an exemplary embodiment of the present disclosure, a welding joint may include the above-described alloying elements and the balance of iron (Fe) and impurities inevitably added during manufacturing processes. Owing to the above-described alloying elements, the welding joint of the exemplary embodiment may have high impact resistance and abrasion resistance. In addition to the above-described alloying elements, the welding joint of the exemplary embodiment may further include the following alloying elements. In this case, the properties of the welding joint may be further improved.

Ni: 10 wt % or Less

Nickel (Ni) forms austenite by solid-solution strengthening and thus improves low-temperature toughness. Nickel (Ni) increases the toughness of welding joints by facilitating the formation of austenite, and thus welding joints having high hardness may not undergo brittle fracture. If the content of nickel (Ni) is greater than 10 wt %, although toughness markedly increases, abrasion resistance markedly decreases because of an increase in stacking fault energy. In addition, since nickel (Ni) is expensive, the addition of a large amount of nickel (Ni) is not preferred in terms of economical aspects. Therefore, it may be preferable that the content of nickel (Ni) be within the range of 10 wt % or less.

V: 5 wt % or Less

Vanadium (V) dissolves in steel and retards the transformation of ferrite and bainite, thereby promoting the formation of martensite. In addition, vanadium (V) promotes solid-solution strengthening and precipitation strengthening. However, the addition of an excessively large amount of vanadium (V) does not further increase the above-described effects but decreases toughness and weldability and increases manufacturing costs. Therefore, the content of vanadium (V) may preferably be 5 wt % or less.

Nb: 5 wt % or Less

Niobium (Nb) may increase the strength of welding joints by precipitation strengthening. However, the addition of an excessively large amount of vanadium (V), as well as increasing manufacturing costs, may cause the formation of coarse precipitates and may thus decrease abrasion resistance. Thus, the content of niobium (Nb) may preferably be 5 wt % or less.

Mo: 7 wt % or Less

Molybdenum (Mo) may increase the strength of welding joints by matrix solid-solution strengthening. Furthermore, like niobium (Nb) and vanadium (V), molybdenum (Mo) promotes precipitation strengthening. However, the addition of an excessively large amount of molybdenum (Mo) does not further increase the above-described effects but worsens toughness and weldability and increases steel manufacturing costs. Therefore, it may be preferable that the content of molybdenum (Mo) be within the range of 7 wt % or less.

W: 6 wt % or Less

Tungsten (W) may increase the strength of welding joints by matrix solid-solution strengthening. Furthermore, like niobium (Nb), vanadium (V), and molybdenum (Mo), tungsten (W) promotes precipitation strengthening. However, the addition of an excessively large amount of tungsten (W) does not further increase the above-described effects but worsens toughness and weldability and increases steel manufacturing costs. Therefore, it may be preferable that the content of tungsten (W) be within the range of 6 wt % or less.

Cu: 2 wt % or Less

Copper (Cu) promotes the formation of austenite and improves the strength of welding joints. However, if the content of copper (Cu) is greater than 2 wt %, blue embrittlement may occur, and price competiveness may decrease. Therefore, it may be preferable that the content of copper (Cu) be within the range of 2 wt % or less.

B: 0.01 wt % or Less

Even a small amount of boron (B) increases strength by sold-solution strengthening and thus improves abrasion resistance. However, if the content of boron (B) is greater than 0.01 wt %, impact toughness may markedly decrease. Thus, the content of boron (B) may preferably be 0.01 wt % or less.

According to the exemplary embodiment, it may be preferable that the stacking fault energy of the welding joint be within the range of 15 J/m2 to 40 mJ/m² at 20° C. If the stacking fault energy of the welding joint is adjusted as described above, the mechanism of plastic deformation of the welding joint caused by external stress changes from dislocation slippage to twining, thereby guaranteeing a high degree of abrasion resistance and a high degree of impact toughness. As the stacking fault energy of the welding joint approaches 15 mJ/m², the formation of s-martensite having a hexagonal close-packed (HCP) structure is facilitated. Such twinning and s-martensite markedly improve the abrasion resistance and impact toughness of the welding joint. Although s-martensite markedly increases abrasion resistance, s-martensite decreases impact toughness. Therefore, the fraction of s-martensite in the welding joint is properly adjusted. If the stacking fault energy of the welding joint is less than 15 mJ/m², s-martensite is formed in the welding joint in an amount of 80% or greater. In this case, the low-temperature impact toughness of the welding joint is very low. Conversely, if the stacking fault energy of the welding joint is greater than 40 mJ/m², the mechanism of plastic deformation of the welding joint caused by external stress changes from twinning to dislocation slippage, and thus the abrasion resistance of the welding joint decreases. Therefore, it may be preferable that the stacking fault energy of the welding joint be within the range of 15 mJ/m² to 40 mJ/m². Stacking fault energy may be measured using various methods or formulas. For example, stacking fault energy may be measured by a simple method of using a commercial program, JmatPro Ver 7.0.

The welding joint of the exemplary embodiment may have a high degree of weldability and a low-temperature impact toughness of 27 J or higher at −29° C., that is, a high degree of impact resistance. When compared to API-X70 steel of the related art used in the oil sands industry, the welding joint of the exemplary embodiment may have relatively high abrasion resistance, for example, an abrasion ratio of 70% or less in an abrasion test according to American Society for Testing and Materials (ASTM) G65. Therefore, the welding joint may be usefully used for parts such as slurry pipes in the oil sands industry.

### MODE FOR INVENTION

Hereinafter, embodiments of the present disclosure will be described more specifically through examples. However, the examples are for clearly explaining the embodiments of the present disclosure and are not intended to limit the scope of the present invention.

Welding joints having the compositions illustrated in Tables 1 and 2 were formed, and the weldability, stacking fault energy, low-temperature impact toughness, and abrasion resistance of the welding joints were measured as illustrated in Table 2. At that time, weldability was evaluated by observing the formation of cracks or pores. The weldability of welding joints having no cracks or pores was evaluated as being “good,” and the weldability of welding joints having cracks or pores was evaluated as being “poor.” In addition, the abrasion resistance of the welding joints was evaluated by performing an abrasion test on the welding joints according to American Society for Testing and Materials (ASTM) G65, and comparing abrasion amounts of the welding joints with results of an abrasion test performed on API-X70 steel generally used in the oil sands industry. The average abrasion amount of API-X70 steel was 2.855 g.

TABLE 1

| | Composition (wt %) | | | | | | | | | |
|---|---|---|---|---|---|---|---|---|---|---|
| Nos. | C | Mn | Si | Cr | P | S | N | Ni | Cu | B |
| *IS1 | 0.25 | 23.2 | 0.42 | 3.12 | 0.015 | 0.01 | 0.002 | — | — | — |
| IS2 | 0.49 | 23.2 | 0.52 | 3.04 | 0.014 | 0.012 | 0.002 | — | — | — |
| IS3 | 0.71 | 23.4 | 0.72 | 3.15 | 0.003 | 0.002 | 0.003 | — | — | — |
| IS4 | 0.27 | 23.1 | 0.4 | 3.01 | 0.013 | 0.013 | 0.004 | 0.92 | 0.98 | — |
| IS5 | 0.21 | 18.2 | 0.32 | 3.17 | 0.006 | 0.004 | 0.001 | 4.89 | 1.55 | — |
| IS6 | 0.12 | 15.3 | 0.21 | 2.98 | 0.012 | 0.009 | 0.004 | 9.23 | — | — |
| IS7 | 0.27 | 23.4 | 0.37 | 2.98 | 0.018 | 0.013 | 0.004 | — | — | — |
| IS8 | 0.18 | 22.9 | 0.42 | 3.02 | 0.017 | 0.011 | 0.102 | — | — | 0.002 |
| IS9 | 0.11 | 25.1 | 0.54 | 2.96 | 0.014 | 0.01 | 0.231 | — | — | 0.005 |
| IS10 | 0.31 | 25.4 | 0.42 | 2.99 | 0.012 | 0.013 | 0.003 | — | — | — |
| IS11 | 0.34 | 24.9 | 0.22 | 3.12 | 0.012 | 0.013 | 0.003 | — | — | — |
| IS12 | 0.31 | 24.3 | 0.42 | 3.04 | 0.009 | 0.008 | 0.004 | — | — | — |
| IS13 | 0.33 | 25.4 | 0.32 | 2.87 | 0.012 | 0.009 | 0.003 | — | — | — |
| IS14 | 0.29 | 26.3 | 0.54 | 3.02 | 0.011 | 0.021 | 0.004 | — | — | — |
| IS15 | 0.28 | 23.2 | 0.43 | 2.99 | 0.009 | 0.009 | 0.003 | — | — | — |
| IS16 | 0.27 | 24.2 | 0.52 | 2.01 | 0.012 | 0.011 | 0.003 | — | — | — |
| IS17 | 0.23 | 25.1 | 0.32 | 5.64 | 0.011 | 0.012 | 0.005 | — | — | — |
| IS18 | 0.28 | 22.3 | 0.22 | 5.98 | 0.012 | 0.009 | 0.007 | — | — | — |
| **CS1 | 0.12 | 14.9 | 0.18 | 3.04 | 0.021 | 0.012 | 0.003 | 15.23 | 2.1 | |
| CS2 | 0.09 | 23.2 | 0.38 | 2.89 | 0.012 | 0.009 | 0.001 | — | — | — |
| CS3 | 0.28 | 23.1 | 0.41 | 2.98 | 0.011 | 0.012 | 0.002 | — | — | — |
| CS4 | 0.29 | 24.8 | 0.36 | 3.09 | 0.011 | 0.01 | 0.003 | — | — | — |
| CS5 | 0.28 | 22.3 | 0.36 | 2.98 | 0.012 | 0.006 | 0.003 | — | — | — |
| CS6 | 0.27 | 24.8 | 0.48 | 3.02 | 0.012 | 0.004 | 0.004 | — | — | — |
| CS7 | 0.02 | 25.2 | 0.62 | 2.97 | 0.012 | 0.012 | 0.529 | — | — | 0.012 |
| CS8 | 1.21 | 22.3 | 1.52 | 2.83 | 0.025 | 0.013 | 0.004 | — | — | — |

*IS: Inventive Sample,
**CS: Comparative Sample

TABLE 2

| | | | | | | Properties | | |
|---|---|---|---|---|---|---|---|---|
| | | | | | *SFE 2 | | Impact | Abrasion |
| | Composition (wt %) | | | | (mJ/m) | | toughness | resistance |
| Nos. | V | Nb | Mo | W | (@20° C.) | Weldability | (@−29° C.) | (%) |
| **IS1 | — | — | — | — | 19.7 | Good | 29.3 | 46.2 |
| IS2 | — | — | — | — | 28.5 | Good | 70.4 | 43.8 |
| IS3 | — | — | — | — | 39.5 | Good | 79.2 | 66.2 |
| IS4 | — | — | — | — | 20.6 | Good | 88.9 | 46.9 |
| IS5 | — | — | — | — | 18.1 | Good | 83.8 | 50 |
| IS6 | — | — | — | — | 23 | Good | 85.2 | 61.4 |
| IS7 | — | — | — | — | 20.9 | Good | 32.3 | 40.3 |
| IS8 | — | — | — | — | 23.5 | Good | 32.5 | 42.4 |
| IS9 | — | — | — | — | 34.4 | Good | 43.2 | 56.6 |
| IS10 | 3.12 | — | — | — | 18.8 | Good | 35.1 | 41 |
| IS11 | — | 2.62 | — | — | 16.3 | Good | 34.2 | 38.6 |
| IS12 | — | — | 3.42 | — | 16.6 | Good | 36.6 | 40.3 |
| IS13 | — | — | 5.98 | — | 15.3 | Good | 27.3 | 35.2 |
| IS14 | — | — | — | 1.2 | 23.8 | Good | 62.3 | 45.5 |
| IS15 | — | — | — | 3.52 | 16.1 | Good | 42.2 | 49 |
| IS16 | — | — | — | — | 20.7 | Good | 29.3 | 46.6 |
| IS17 | — | — | — | — | 23.5 | Good | 32.5 | 35.5 |
| IS18 | — | — | — | — | 23 | Good | 35.1 | 31.7 |
| ***CS1 | — | — | — | — | 40.1 | Good | 89.3 | 72.1 |
| CS2 | — | — | — | — | 14.9 | Good | 18.2 | 28.3 |
| CS3 | 6.23 | — | — | — | 13.9 | Good | 24.8 | 35.9 |
| CS4 | — | 6.23 | — | — | −9.9 | Good | 21.3 | 34.8 |
| CS5 | — | — | 8.12 | — | 8 | Good | 19.3 | 31.7 |
| CS6 | — | — | — | 7.12 | 14.5 | Good | 26.1 | 52.4 |
| CS7 | — | — | — | — | 53.3 | Poor | — | — |
| | | | | | | (pores) | | |
| CS8 | — | — | — | — | 60.9 | Poor | — | — |
| | | | | | | (cracks) | | |

*SFE: Stacking Fault Energy,
**IS: Inventive Sample,
***CS: Comparative Sample

As illustrated in Tables 1 and 2 above, the welding joints formed of Inventive Samples 1 to 15 having compositions proposed in the exemplary embodiment of the present disclosure had a high degree of weldability, and a very high degree of impact resistance, that is, a low-temperature impact toughness of 27 J or greater at −29° C. In addition, the abrasion amounts of the welding joints were 2 g or less. That is, the welding joints had high abrasion resistance compared to API-X70 steel of the related art.

However, Comparative Samples 1 to 6 not satisfying alloying element contents proposed in the exemplary embodiment of the present disclosure had low degrees of low-temperature impact toughness and abrasion resistance compared to the inventive samples. In the case of Comparative Samples 7 and 8, it was difficult to perform welding because of unstable arcs or excessive amounts of spatters, and thus low-temperature impact toughness and abrasion resistance could not be evaluated.

1. A welding joint having high impact resistance and abrasion resistance, comprising, by wt %, carbon (C): 0.02% to 0.75%, silicon (Si) : 0.2% to 1.2%, manganese (Mn) : 15% to 27%, chromium (Cr) : 2% to 7%, sulfur (S) : 0.025% or less, phosphorus (P): 0.025% or less, nitrogen (N): 0.001% to 0.4%, and a balance of iron (Fe) and inevitable impurities,
wherein the welding joint has stacking fault energy of 15 mJ/m² to 40 mJ/m² at 20° C.

2. The welding joint of claim 1, further comprising nickel (Ni) in an amount of 10% or less.

3. The welding joint of claim 1, further comprising vanadium (V): 5% or less, niobium (Nb): 5% or less, molybdenum (Mo): 7% or less, and tungsten (W): 6% or less.

4. The welding joint of claim 1, further comprising copper (Cu) in an amount of 2% or less.

5. The welding joint of claim 1, further comprising boron (B) in an amount of 0.01% or less.

6. The welding joint of claim 1, wherein the welding joint has a low-temperature impact toughness of 27 J or greater at a temperature of −29° C.
